(19) United States
(12) Patent Application Publication
(10) Pub. No.: US 2017/0213210 A1
(43) Pub. Date: Jul. 27, 2017

(54) ASSET TRANSFERS USING A MULTI-TENANT TRANSACTION DATABASE

(71) Applicant: International Business Machines Corporation, Armonk, NY (US)

(72) Inventor: David William Kravitz, San Jose, CA (US)

(21) Appl. No.: 15/004,178

(22) Filed: Jan. 22, 2016

(51) Int. Cl. G06Q 20/38; G06Q 20/10

(52) U.S. Cl. CPC G06Q 20/3829; G06Q 20/10

(57) ABSTRACT

One embodiment provides a method for securely transferring an asset between entities using a multi-tenant transaction database, the method including: utilizing at least one processor to execute computer code that performs the steps of: receiving, at the multi-tenant transaction database, an asset token comprising an encrypted identification tag representing an asset owned by a first transacting entity, wherein the encrypted identification tag is associated with a public key having a corresponding private key which is usable for decryption of the encrypted identification tag; receiving, at the multi-tenant transaction database, a transfer request to transfer the asset token from the first transacting entity to a second transacting entity; receiving, at the multi-tenant transaction database, an authorization to complete the transfer request; and transferring, at the multi-tenant transaction database, the asset token to the second transacting entity. Other aspects are described and claimed.

### BACKGROUND

A time-sequenced immutable database, for example implemented using block chain technology (also referenced as “block chain”), is a distributed database that is implemented using a plurality of nodes. The nodes each maintain a copy of a sequentially growing list or ledger of data records or query one or more other nodes. An example of a block chain implementation is a public ledger used for crypto-currency transactions. The data of a block chain may be protected by encryption and may include data other than crypto-currency transactions, e.g., smart contracts may be implemented using a block chain.

The functionality of block chain technology has garnered much interest; however, widespread adoption of such technology has been hindered by reservations regarding anonymous transactions and a lack of clarity as to which entities are involved in a transaction, their past contributions to the database, and their authority to act in certain transactions. Additionally, the digital transfer of assets (e.g., physical products, tickets to entertainment events, and the like) using block chain technology is cumbersome because the person needs to have physical possession of the asset to ensure the person owns the asset to be transferred. Thus, use of block chain technology in transferring assets appears to be cumbersome and unpractical.

### BRIEF SUMMARY

In summary, one aspect of the invention provides a method for securely transferring an asset between entities using a multi-tenant transaction database, the method comprising: utilizing at least one processor to execute computer code that performs the steps of: receiving, at the multi-tenant transaction database, an asset token comprising an encrypted identification tag representing an asset owned by a first transacting entity, wherein the encrypted identification tag is associated with a public key having a corresponding private key which is usable for decryption of the encrypted identification tag; receiving, at the multi-tenant transaction database, a transfer request to transfer the asset token from the first transacting entity to a second transacting entity; receiving, at the multi-tenant transaction database, an authorization to complete the transfer request; and transferring, at the multi-tenant transaction database, the asset token to the second transacting entity.

Another aspect of the invention provides an apparatus for securely transferring an asset between entities using a multi-tenant transaction database, the apparatus comprising: at least one processor; and a computer readable storage medium having computer readable program code embodied therewith and executable by the at least one processor, the computer readable program code comprising: computer readable program code that receives, at the multi-tenant transaction database, an asset token comprising an encrypted identification tag representing an asset owned by a first transacting entity, wherein the encrypted identification tag is associated with a public key having a corresponding private key which is usable for decryption of the encrypted identification tag; computer readable program code that receives, at the multi-tenant transaction database, a transfer request to transfer the asset token from the first transacting entity to a second transacting entity, wherein the transfer request comprises a time limit for completing the transfer request; computer readable program code that receives, at the multi-tenant transaction database, an authorization to complete the transfer request; and computer readable program code that transfers, at the multi-tenant transaction database, the asset token to the second transacting entity.

An additional aspect of the invention provides a computer program product for securely transferring an asset between entities using a multi-tenant transaction database, the computer program product comprising: a computer readable storage medium having computer readable program code embodied therewith, the computer readable program code comprising: computer readable program code that receives, at the multi-tenant transaction database, an asset token comprising an encrypted identification tag representing an asset owned by a first transacting entity, wherein the encrypted identification tag is associated with a public key having a corresponding private key which is usable for decryption of the encrypted identification tag; computer readable program code that receives, at the multi-tenant transaction database, a transfer request to transfer the asset token from the first transacting entity to a second transacting entity; computer readable program code that receives, at the multi-tenant transaction database, an authorization to complete the transfer request; and computer readable program code that transfers, at the multi-tenant transaction database, the asset token to the second transacting entity.

A further aspect of the invention provides a method of securely transferring an asset between entities using a multi-tenant transaction database, the method comprising: utilizing at least one processor to execute computer code that performs the steps of: receiving, at the multi-tenant transaction database, an asset token comprising a digitally signed encrypted identification tag representing an asset owned by a first transacting entity, wherein the encrypted identification tag is associated with a public key having a corresponding private key which is usable for decryption of the encrypted identification tag; receiving, at the multi-tenant transaction database, a transformation request, wherein the transformation request requests the asset token be transformed into a redeemable ticket; and transforming, at the multi-tenant transaction database, the asset token into a redeemable ticket, the transforming comprising decrypting the encrypted identification tag using the private key and encrypting the identification tag using a public key for which a corresponding private key is associated with the second transacting entity.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of asset transfers using a multi-tenant transaction database.

FIG. 2 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

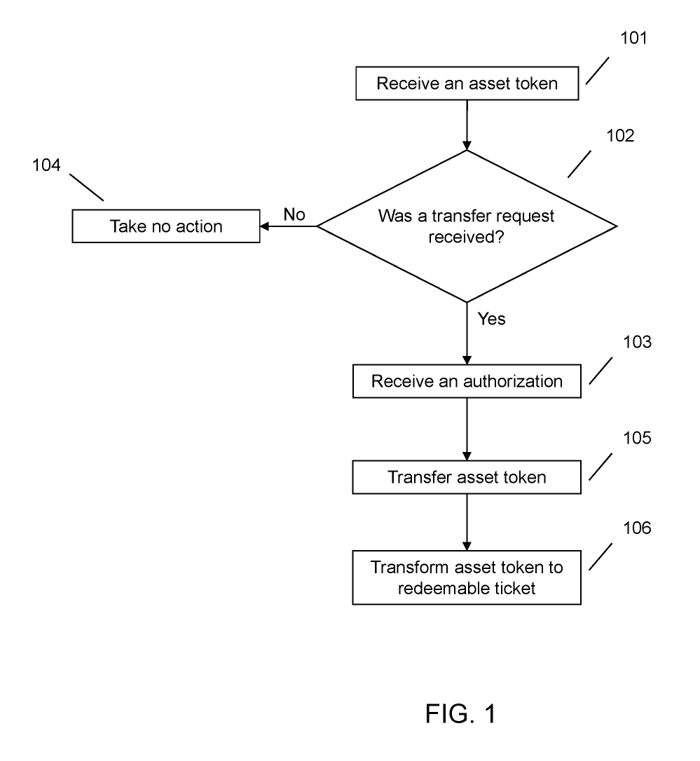

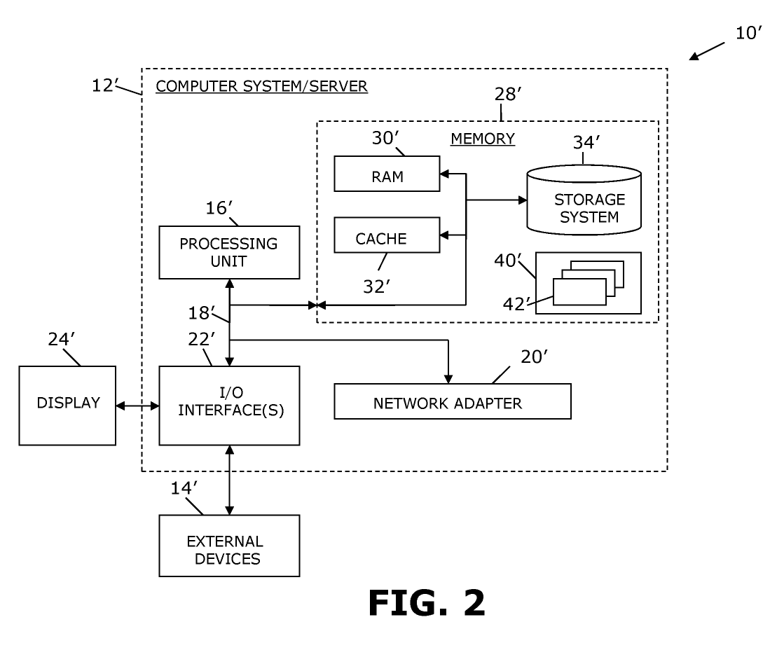

Specific reference will be made here below to FIG. 1. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 2. In accordance with an example embodiment, most if not all of the process steps, components and outputs discussed with respect to FIG. 1 can be performed or utilized by way of a processing unit or units and system memory such as those indicated, respectively, at 16′ and 28′ in FIG. 2, whether on a server computer, a client computer, a node computer in a distributed network, or any combination thereof.

It is desirable to expand the use of time-sequenced immutable databases, for example ones that are constructed using block chain technology, beyond digital currency transactions and asset transfers that are conducted anonymously or pseudonymously. Further, it is desirable to use the block chain technology to transfer assets between entities in a way that preserves the interests of originators, producers, sellers, and buyers of the asset. Additionally, it is desirable to have a system which allows a seller to transfer an asset before the seller may have usable possession of the asset.

Accordingly, an embodiment provides a method for securely transferring an asset between entities using a multi-tenant database, even if the current seller does not have usable possession of the asset. In other words, even if the asset is not yet in a usable form, the seller may still transfer the asset to a new owner. The system may be particularly useful for virtual assets, assets redeemable at physical venues (e.g., live concert tickets, theater tickets, sporting event tickets, etc.), limited-availability content licenses or content access, and the like, but may also be used for any asset of which ownership may be transferred virtually. An embodiment may receive an asset token having an encrypted identification tag representing an asset owned by a first transacting entity (referred to as “seller”). The identification tag or alternatively the asset token or a plaintext/cleartext version of the asset token may be encrypted via use of a public key, and a corresponding private key may be provided to an authorized user for later decryption.

Upon receiving a request to transfer the asset from the first transacting entity to a second transacting entity (referred to as “buyer”), an embodiment may wait to transfer the asset until an authorization is received. The authorization may include a proof of payment transaction or a verification by the seller that the terms of the transfer have been met. An embodiment may then facilitate the transfer of the asset from the seller to the buyer. Such a system allows the asset to be transferred even if the seller does not have usable possession of the asset. Additionally, the buyer can be assured that the asset is valid and the seller is validly able to sell or transfer the asset.

Such a system provides a technical improvement over current systems for digital asset transfers in that the system is more secure and the interests of all parties involved can be preserved. For example, a seller can transfer an asset before having usable possession of the asset and a buyer can be assured that the transfer of the asset is valid. Additionally, such a system prevents the seller from being able to sell a single asset to multiple buyers, which reduces the need for invoking measures for dispute resolution. The system provides a method of encrypting the asset or the asset identification information so that the transfer of the asset is secure and is not compromised.

Referring now to FIG. 1, an embodiment may, at 101, receive at the multi-tenant database, an asset token. Receiving the asset token may include a customer uploading a transaction or asset to the multi-tenant database. For example, a customer may purchase an asset using a method outside the block chain (e.g., credit card payment, wire transfer off the block chain, etc.) or from a location that is not included on the multi-tenant database (e.g., brick and mortar store, online from a business not included on the database, etc.). The customer may then upload the transaction, asset, identification information for the asset, or other representative information, to the multi-tenant database so that the asset can be included within the database. Receiving the asset token may also include a business storing the asset token within the database. For example, a customer may buy an asset from an online source that then places the asset token within the database.

The asset token may be linked to the seller's address. For example, the seller may have an address on the block chain and the asset token may be linked to this address. If the seller purchases the asset from a business within the block chain, the asset token may be output to the seller's address. If the seller introduces the asset token to the multi-tenant database, then the asset token may be placed at or linked with the seller's address on the block chain.

The asset token may include an identification tag which may include information which identifies the asset owned by the first transacting entity (“seller”). In one embodiment, the information may include a unique representative number for the asset. The identification tag may include additional information. For example, if the asset is a limited edition art print, the identification tag may include the specific number of the art print. As another example, if the asset is a ticket for an entertainment event, the identification tag may include the seat number corresponding to the ticket. Other information may be included in the identification tag to identify the asset, for example, the value of the asset, publisher of the asset, name of the asset, and the like. An identification tag may include a value computed as a function of a virtual asset. An identification tag may alternatively or additionally include a key or an encrypted key whereby such key is used to encrypt a virtual asset or to encrypt a key that is used to encrypt a virtual asset.

Other information may additionally or alternatively be included in the asset token as part of, in addition to, or instead of, an identification tag. Such other information may include cryptographic key(s), encrypted cryptographic key(s), encrypted asset, encrypted partial asset, and the like. As an example of a cryptographic key, such key may be a public key that is used in conjunction with an intended recipient's private key to derive a shared secret value that is used to derive one or more keys.

The identification tag or asset token may also be digitally signed (e.g., to assure source authentication and/or data integrity), or uniquely numbered to identify the tag or token. A digitally signed encrypted identification tag representing an asset may be generated by applying a digital signature to the identification tag wherein such processing involves applying a hash function (e.g., a one-way hash function) to an encrypted form of the identification tag. Alternatively, such processing may involve applying a hash function to the plaintext or cleartext form of the identification tag. In either case, the actual encrypted identification tag may be communicated and/or handled separately form the multi-tenant transaction database.

In one embodiment, the identification tag may be a digital representation of the asset. For example, in the case of an art print, the identification tag may include a digital representation of the art print. As another example, if the asset is a file for a three-dimensional (3-D) printer, the identification tag may include a digital representation of the file. If the asset includes a file, the file may be digitally signed for data integrity. The file may additionally be source-entity authenticated. In one embodiment, the file may be encrypted and transmitted independently from the database. For example, if the file is large, rather than taking up space on the database, the file may be stored elsewhere and then transmitted independently from the database when a transfer occurs. The encrypted file may alternatively be available independently from the transfer via the multi-tenant database. In such a transfer, access to a key required to decrypt the file may be controlled at least in part via the multi-tenant database. As an example, assume that an entity requests, via the multi-tenant database, to transform an asset token into a redeemable ticket, as discussed further below. The response to the request may include an encrypted field that, after decryption by the entity that requested the asset token transformation, exposes an encrypted key that can be decrypted by a specific printer or other device. After such decryption by the printer or device, the resulting key is used in the process of accessing the plaintext asset, such as a digital representation of the asset.

The identification tag or asset token may be encrypted, or the asset token may include one or more encrypted fields. In one embodiment, encryption of the tag may be completed using an encryption public key. In this type of encryption the public key may be used directly for the encryption of the tag or asset token or pre-encryption form of the asset token, for encryption of a symmetric key that is used for encryption of the tag or asset token or pre-encryption form of the asset token, for encryption of a symmetric key that is used for encryption of another symmetric key that is used for encryption of the tag or asset token or pre-encryption form of the asset token, and the like. For example, this type of encryption may be accomplished using an RSA algorithm.

Encryption of the tag or token or pre-encryption form of the token may alternatively be completed using a key agreement public key. In this type of encryption, the public key may be used to derive a shared secret value, for example, using a Diffie-Hellman algorithm or elliptic curve Diffie-Hellman algorithm, that is used to derive a key used to encrypt the tag or token or pre-encryption form of the token, to encrypt a symmetric key that is used to encrypt the tag or token or pre-encryption form of the token, to encrypt a symmetric key that is used to encrypt another symmetric key that is used to encrypt the tag or token or pre-encryption form of the token, and the like. The encrypted form of the identification tag or of the asset token or of the pre-encryption form of the asset token may be associated with a corresponding private key for later decryption. Other types of encryption are possible and contemplated. For example, in one embodiment, the public key may be used indirectly to derive a shared secret value from which a symmetric key is derived, where knowledge of the symmetric key is accessible via application of the corresponding private key. The symmetric key may be used to encrypt a key that is used to encrypt an asset and/or identification tag or to encrypt a key that is in a hierarchy of keys in which a key lowest in the hierarchy is used to encrypt the asset and/or identification tag.

In one embodiment, the asset token may be made available to a broker on a block chain. The broker may receive the asset token to ensure that the asset token cannot be used by an unauthorized party during a transaction. In one embodiment, the broker that is expected to process a transfer request may be selected before an access token is generated or before a transfer is started, in which case the broker's block chain address (i.e., a destination address to which a transfer request is output and that is associated with a public key that is used to verify a digital signature subsequently generated by the broker) is known. Alternatively, the token or tag may be encrypted for multiple brokers, and the broker may be selected later. The broker may act as a middle man or middle device to ensure that the asset is only part of a single transaction at a time. Also, the broker may facilitate the transaction between the seller and buyer by performing the steps necessary for transferring the asset and preventing actions from happening until necessary terms are fulfilled. Additionally, the broker may be automated and perform actions upon fulfillment of conditions.

At 102, an embodiment may identify whether a transfer request has been received. A transfer request may include a request to transfer the asset token from the seller to a second transacting entity (“buyer”). The transfer request may additionally include a time limit for completing the transfer request, an identification address of the buyer, and a monetary amount associated with the transfer of the asset. The time limit for completing the transfer request may include how long the buyer has to provide payment for the asset. Payment for the asset does not have to occur on the multi-tenant ledger database such as a block chain. For example, the buyer may provide payment through a credit or debit card, a check, money order, wire transfer off the block chain, or other form of payment. The identification address of the buyer may include a block chain address of the buyer. Such block chain addresses may be pseudonymous, for example, such a block chain address need not necessarily identify the individual buyer and/or that individual may use other block chain addresses at other times for other transactions. Block chain addresses of sellers may likewise be pseudonymous.

The monetary amount associated with the transfer of the asset may include an amount that the buyer is paying for the asset, the amount the seller is charging to transfer the asset within the block chain, an amount that is a processing fee due to the broker, and/or other amount(s). In some cases the monetary amount associated with the asset may be zero. In other words, even if the seller is giving an asset to the buyer without requesting or receiving monetary compensation, the transfer of the asset can be facilitated using the block chain. A barter system, for example, could make use of such non-monetary compensation transfers. A transfer request may also include an offer by a buyer to purchase a particular asset token from a seller. For example, a buyer may know that a seller owns a particular asset and may request that the seller sell the asset.

If a transfer request is not received at 102, an embodiment may take no action at 104. The system may perform other actions if no transfer request is received. For example, an embodiment may instead receive a transformation request, as discussed in more detail herein. However, if a transfer request is received at 102, an embodiment may receive an authorization to complete the transfer request at 103. An authorization may include a verification by the seller that the buyer has fulfilled the terms of the transfer and the asset can be transferred to the buyer. For example, if the buyer pays for the asset off the block chain, the seller may provide a receipt that the payment has been made. Alternatively, the buyer may submit a receipt that the payment has been made. As a further alternative, a third-party entity such as a payment processor may submit a receipt indicating that the payment has been made. As another example, the seller may provide written authorization (e.g., digital signature, manual selection indicating authorization, faxed authorization, etc.) to complete the transfer based upon terms the seller may set or require. In one embodiment, an authorization may include a transaction conducted within the block chain of the buyer providing the payment amount to the seller. Alternatively, the funds may be provided to the broker and upon transferring the asset token to the buyer, the broker may transfer the funds to the seller. If a time limit is associated with the transfer request, the authorization may need to be received within the time limit.

In the case of a buyer offering to buy an asset from a seller, the buyer may provide payment to the broker who may then hold the payment until the seller accepts or rejects the offer, or until it is determined that the candidate seller is non-responsive to the offer. Upon acceptance of the offer, the broker may transfer the funds to the seller. Upon rejection of the offer, the broker may refund the funds to the buyer. Alternatively, the seller may neither accept nor reject the offer, in which case the broker may refund the funds to the buyer upon the expiration of a time limit which may be predetermined or selected by the buyer or broker.

After receiving the authorization at 103, an embodiment may transfer the asset token to the buyer at 105, for example, through the use of a smart contract. In transferring the asset token the broker may submit an asset token transfer response transaction to the block chain which transfers the asset token from the seller to the buyer. The broker knows a block chain address of each of the buyer and seller allowing the broker to transfer the asset token from the seller's address to the buyer's address. If another buyer offers to purchase the asset token from the seller while a transfer request is awaiting an authorization, the new offer may not be considered until and unless the seller denies the original transaction. Alternatively, if the time limit expires on the first transfer request the new offer may be considered.

At 106, an embodiment may transform the asset token into a redeemable ticket. The redeemable ticket may include a representation of the asset that can be redeemed without requiring any further interaction with the multi-tenant database or with any processor associated with the multi-tenant database. The transformation may occur in response to receiving a request from the current asset holder to redeem the asset or to turn the asset into a usable form. Transforming the asset token may include decrypting the encrypted identification tag or asset token using the private key. For example, if the broker has the private key associated with the encryption of the identification tag, the broker may decrypt the identification tag. Alternatively, the private key may be transferred to the current asset owner and the asset owner may decrypt the encrypted tag or token.

In some cases an entity associated with the transformation request corresponding to a virtual asset may not be able to access the virtual asset directly using the transformation response. For example, the identification tag may include an encrypted key that has been encrypted in order to limit access to the virtual asset, and the access is specific to another entity, such as a specific printer or 3D printer. Such another entity may be digital rights management (DRM) protected. The intent of such DRM protection may be to assure that the entity produces only a single instance of the physical output that is derived from the virtual asset. The encrypted key that has been encrypted for use by the entity may be further encrypted using a key that is derivable by the entity associated with the transformation request using that entity's private key.

Such further encryption can involve use of a public key that corresponds to the private key that is available to the entity that produces or is associated with the transformation request. After this entity uses its private key to perform the decryption operation, it can pass the result to the another entity, such as a printer or 3D printer, that can decrypt in order to recover a key that is usable to access the unencrypted form of the virtual asset. The entity may be equipped with a digital certificate that includes or allows reconstruction of a public key that is used in the process of encryption that targets that specific entity with the capability to access the unencrypted form of the virtual asset. As another example, an asset may be a ticket to a physical venue, such as a concert, movie or theater production. The ticket derived from a redeemable ticket via decryption using the private key available to an entity associated with the transformation request may be indistinguishable by a ticket collector or scanner apparatus at the physical venue from a ticket that could have been sold directly without entailing the use of the current invention.

Transforming the asset token may also include re-encrypting the identification tag or asset token using a public key held by the buyer or current asset owner. The buyer or current asset owner may then decrypt the identification tag or asset token using their private key. The re-encrypting can be accomplished using one or more of the encryption methods discussed above. The identification tag or asset token that is thus re-encrypted may not necessarily be identical to the original identification tag or asset token. For example, certain fields may be added, deleted, substituted, and the like. Once the asset token is transformed, this may serve as an alert to the broker that no further transactions of the types discussed herein can legitimately be performed relative to the asset.

In an alternative embodiment, transformation of an asset token need not be prefaced or preceded by transfer of the asset token via a transfer request. For example, an entity or consumer can purchase or otherwise come into possession of an asset token, and ultimately use or consume the asset as a result of transformation of the asset token without there being any preceding transfer request relative to that asset token or an associated asset token. In yet another embodiment, transfer may occur via a transfer request relative to an asset token from a first entity to a second entity later followed by a transfer of that asset token or an associated asset token to the first entity.

As shown in FIG. 2, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for securely transferring an asset between entities using a multi-tenant transaction database, the method comprising:
utilizing at least one processor to execute computer code that performs the steps of:
receiving, at the multi-tenant transaction database, an asset token comprising an encrypted identification tag representing an asset owned by a first transacting entity, wherein the encrypted identification tag is associated with a public key having a corresponding private key which is usable for decryption of the encrypted identification tag;
receiving, at the multi-tenant transaction database, a transfer request to transfer the asset token from the first transacting entity to a second transacting entity;
receiving, at the multi-tenant transaction database, an authorization to complete the transfer request; and
transferring, at the multi-tenant transaction database, the asset token to the second transacting entity.

2. The method of claim 1, wherein the transfer request comprises a monetary amount for the transfer of the asset token.

3. The method of claim 2, wherein the authorization comprises a transaction indicating the second transacting entity has provided the monetary amount to the first transacting entity.

4. The method of claim 1, comprising transforming the asset token into a redeemable ticket, the transforming comprising decrypting the encrypted identification tag using the private key and encrypting the identification tag using a public key of the second transacting entity.

5. The method of claim 1, wherein the transfer request comprises a time limit for completing the transfer request and wherein the authorization is received within the time limit.

6. The method of claim 1, wherein the encrypted identification tag comprises an identification tag encrypted using a public key encryption.

7. The method of claim 1, wherein the encrypted identification tag comprises an identification tag encrypted using a key agreement public key.

8. The method of claim 1, wherein the encrypted identification tag is digitally signed.

9. The method of claim 1, wherein the asset comprises a digital representation comprising at least one electronic file.

10. The method of claim 9, wherein the at least one electronic file is encrypted and transmitted independently from the multi-tenant transaction database.

11. The method of claim 1, wherein the transfer request comprises an identification address of the second transacting entity.

12. An apparatus for securely transferring an asset between entities using a multi-tenant transaction database, the apparatus comprising:
at least one processor; and
a computer readable storage medium having computer readable program code embodied therewith and executable by the at least one processor, the computer readable program code comprising:
computer readable program code that receives, at the multi-tenant transaction database, an asset token comprising an encrypted identification tag representing an asset owned by a first transacting entity, wherein the encrypted identification tag is associated with a public key having a corresponding private key which is usable for decryption of the encrypted identification tag;
computer readable program code that receives, at the multi-tenant transaction database, a transfer request to transfer the asset token from the first transacting entity to a second transacting entity;
computer readable program code that receives, at the multi-tenant transaction database, an authorization to complete the transfer request; and
computer readable program code that transfers, at the multi-tenant transaction database, the asset token to the second transacting entity.

13. A computer program product for securely transferring an asset between entities using a multi-tenant transaction database, the computer program product comprising:
a computer readable storage medium having computer readable program code embodied therewith, the computer readable program code comprising:
computer readable program code that receives, at the multi-tenant transaction database, an asset token comprising an encrypted identification tag representing an asset owned by a first transacting entity, wherein the encrypted identification tag is associated with a public key having a corresponding private key which is usable for decryption of the encrypted identification tag;
computer readable program code that receives, at the multi-tenant transaction database, a transfer request to transfer the asset token from the first transacting entity to a second transacting entity;
computer readable program code that receives, at the multi-tenant transaction database, an authorization to complete the transfer request; and
computer readable program code that transfers, at the multi-tenant transaction database, the asset token to the second transacting entity.

14. The computer program product of claim 13, wherein the transfer request comprises a monetary amount for the transfer of the asset token and wherein the authorization comprises a transaction indicating the second transacting entity has provided the monetary amount to the first transacting entity.

15. The computer program product of claim 13, comprising transforming the asset token into a redeemable ticket, the transforming comprising decrypting the encrypted identification tag using the private key and encrypting the identification tag using a public key of the second transacting entity.

16. The computer program product of claim 13, wherein the transfer request comprises a time limit for completing the transfer request and wherein the authorization is received within the time limit.

17. The computer program product of claim 13, wherein the encrypted identification tag comprises an identification tag encrypted using a public key encryption.

18. The computer program product of claim 13, wherein the encrypted identification tag comprises an identification tag encrypted using a key agreement public key.

19. The computer program product of claim 13, wherein the encrypted identification tag is digitally signed.

20. A method of securely transferring an asset between entities using a multi-tenant transaction database, the method comprising:
utilizing at least one processor to execute computer code that performs the steps of:
receiving, at the multi-tenant transaction database, an asset token comprising a digitally signed encrypted identification tag representing an asset owned by a first transacting entity, wherein the encrypted identification tag is associated with a public key having a corresponding private key which is usable for decryption of the encrypted identification tag;
receiving, at the multi-tenant transaction database, a transformation request, wherein the transformation request requests the asset token be transformed into a redeemable ticket; and
transforming, at the multi-tenant transaction database, the asset token into a redeemable ticket, the transforming comprising decrypting the encrypted identification tag using the private key and encrypting the identification tag using a public key for which a corresponding private key is associated with the second transacting entity.
